(19) United States
(12) Patent Application Publication
(10) Pub. No.: US 2026/0274233 A1
(43) Pub. Date: Sep. 17, 2026

(54) BRAKE APPARATUS FOR VEHICLES

(71) Applicant: HYUNDAI MOBIS CO., LTD., Seoul (KR)

(72) Inventor: Si Yoon PARK, Yongin-si (KR)

(73) Assignee: HYUNDAI MOBIS CO., LTD., Seoul (KR)

(21) Appl. No.: 19/307,700

(22) Filed: Aug. 22, 2025

(30) Foreign Application Priority Data
Oct. 18, 2024 (KR) 10-2024-0143037
Oct. 18, 2024 (KR) 10-2024-0143039

(51) Int. Cl. B60T 13/74; F15B 21/00

(52) U.S. Cl. CPC B60T 13/745; F15B 21/008

(57) ABSTRACT

A brake apparatus for vehicles includes a cylinder, a motor coupled to the cylinder, and configured to generate rotational power, a screw shaft disposed inside the cylinder, receiving the rotational power from the motor and rotating around an axis thereof, a nut coupled to the screw shaft via a ball, and reciprocating in an axial direction of the screw shaft according to a rotational direction of the screw shaft, a piston coupled to the nut, and moving in conjunction with the nut, a sleeve provided inside the cylinder, and configured to guide movement of the piston inserted in the sleeve, and a damper coupled to the screw shaft and being elastically deformable.

### CROSS-REFERENCE TO RELATED APPLICATION

This application claims priority from and the benefit of Korean Patent Application Nos. 10-2024-0143037 and 10-2024-0143039, filed on Oct. 18, 2024 and Oct. 18, 2024, respectively, which are hereby incorporated by reference for all purposes as if set forth herein.

### BACKGROUND

### Field

Exemplary embodiments of the present disclosure relate to a brake apparatus for vehicles, and more particularly, to a brake apparatus for vehicles in which a rotational motion of a screw shaft, which is rotated by receiving rotational force from a motor, may be converted into a linear motion of a piston.

### Discussion of the Background

In general, due to the characteristics of electrically-powered brake apparatuses for vehicles, a mechanism configured to convert a rotational motion of a motor into a linear motion of a piston in a cylinder to generate hydraulic brake pressure is required.

A ball screw device is applied to an electric brake apparatus as the mechanism for converting the rotational motion of the motor into the linear motion. The ball screw device includes a screw shaft that receives rotational force from the motor and rotates on an axis, a nut coupled to the screw shaft via balls and configured to move in an axial direction of the screw shaft, and a piston coupled to the nut and configured to pressurize a working fluid in the cylinder.

In conventional arts, during a process of generating hydraulic brake pressure, resonance occurring in the ball screw device may cause problems such as damage to a coupling portion with a motor, degradation in system performance, and generation of vibration and noise. Accordingly, an improvement is required to resolve the above-described problems.

The background art of the present disclosure is disclosed in Korean Patent Laid-open Publication No. 10-2021-0064367 (published on Jun. 2, 2021, entitled “Hydraulic Unit for Hydraulic Vehicle Brake System”).

### SUMMARY

Various embodiments are directed to providing a brake apparatus for vehicles that can reduce resonance generated in a screw shaft.

Various embodiments are directed to providing a brake apparatus for vehicles that can convert rotational motion of a screw shaft, which is rotated by receiving rotational force from a motor, into linear motion of a piston.

In order to accomplish the above objects, a brake apparatus for vehicles according to an embodiment of the present disclosure may include: a cylinder; a motor coupled to the cylinder, and configured to generate rotational power; a screw shaft disposed inside the cylinder, receiving the rotational power from the motor and rotating around an axis thereof; a nut coupled to the screw shaft via a ball, and reciprocating in an axial direction of the screw shaft according to a rotational direction of the screw shaft; a piston coupled to the nut, and moving in conjunction with the nut; a sleeve provided inside the cylinder, and configured to guide movement of the piston inserted in the sleeve; and a damper coupled to the screw shaft and being elastically deformable.

The piston may include: a rod threadedly engaged with an outer surface of the nut; and a head integrally formed with the rod, and reciprocating inside the sleeve in a longitudinal direction of the sleeve.

The brake apparatus may further include a shaft bearing provided inside the cylinder, and coupled to the screw shaft, the shaft bearing supporting an axial load during formation of hydraulic pressure in the cylinder.

The screw shaft may include: a screw body rotatably disposed around an axis thereof in the cylinder; a neck portion protruding from the screw body; a power transmission portion extending from the neck portion, and receiving the rotational power from the motor; and a shaft cover enclosing the neck portion and the power transmission portion.

The damper may include a metallic material. The shaft cover may include a plastic material.

A diameter of the power transmission portion may be greater than a diameter of the neck portion.

A gap may be formed between the neck portion and the shaft cover.

The damper may include: a damper body interposed between the shaft cover and the neck portion, and enclosing the neck portion; and an elastic portion protruding convexly from the damper body, and elastically supporting the shaft cover.

The elastic portion may protrude from an outer circumferential surface of the damper body in a radial direction of the damper body, and may be formed in a circumferential direction of the damper body.

The damper body may be formed in a ring shape with one side of an outer circumferential surface thereof open.

A brake apparatus for vehicles according to an embodiment of the present disclosure may include: a cylinder; a motor configured to generate rotational power; a screw shaft disposed inside the cylinder, receiving the rotational power from the motor and rotating around an axis thereof; a nut coupled to the screw shaft, and reciprocating in an axial direction of the screw shaft according to rotation of the screw shaft; a sleeve disposed between the cylinder and the screw shaft; a piston coupled to the nut, and including a head reciprocating in the sleeve according to the reciprocation of the nut; and a vibration reducer including a first side supported on the screw shaft, and a second side supported on the motor, the vibration reducer being elastically deformable.

The vibration reducer may include a helical coil.

The helical coil may have a discontinuous ring shape.

The helical coil may include a metallic material.

The vibration reducer may include a torsion spring.

The screw shaft may include: a screw body rotatably disposed around an axis thereof in the cylinder; a neck portion protruding from the screw body; and a power transmission portion extending from the neck portion, and receiving the rotational power from the motor. The first side of the vibration reducer may be supported in contact with a stepped portion in a connection region between the screw body and the neck portion.

The second side of the vibration reducer may be supported in contact with a tapered surface of the motor.

The second side of the vibration reducer may be disposed to be spaced farther apart from the sleeve than the first side of the vibration reducer.

The piston may include: a rod coupled to an outer surface of the nut; and the head integrally formed with the rod, and reciprocating in the sleeve in a longitudinal direction of the sleeve.

The brake apparatus may further include a shaft bearing disposed inside the cylinder, and coupled to the screw shaft, the shaft bearing supporting an axial load during formation of hydraulic pressure in the cylinder.

### BRIEF DESCRIPTION OF THE DRAWINGS

FIG. 1 is a sectional view illustrating a brake apparatus for vehicles according to an embodiment of the present disclosure.

FIG. 2 is a perspective view illustrating a cylinder viewed from one direction according to an embodiment of the present disclosure.

FIG. 3 is a perspective view illustrating the cylinder of FIG. 2 viewed from another direction.

FIG. 4 is an exploded perspective view illustrating the cylinder of FIG. 2.

FIG. 5 is an exploded perspective view illustrating the cylinder of FIG. 3.

FIG. 6 is a sectional view illustrating the cylinder according to an embodiment of the present disclosure.

FIG. 7 is an enlarged view showing a portion of FIG. 6.

FIG. 8 is a perspective view illustrating a damper according to an embodiment of the present disclosure.

FIG. 9 is a sectional view showing an operating state in which a piston moves forward into the cylinder in the brake apparatus for vehicles according to an embodiment of the present disclosure.

FIG. 10 is a sectional view showing an operating state in which the piston moves backward inside the cylinder in the brake apparatus for vehicles according to an embodiment of the present disclosure.

FIG. 11 is a sectional view illustrating a brake apparatus for vehicles according to another embodiment of the present disclosure.

FIG. 12 is a perspective view illustrating a cylinder viewed from one direction according to another embodiment of the present disclosure.

FIG. 13 is a perspective view illustrating the cylinder of FIG. 12 viewed from another direction.

FIG. 14 is a sectional view schematically illustrating the brake apparatus for vehicles according to another embodiment of the present disclosure.

FIG. 15 is an enlarged sectional view of a region around a vibration reducer according to another embodiment of the present disclosure.

FIG. 16 is a view showing an operating state in which a piston moves forward inside the cylinder in the brake apparatus for vehicles according to another embodiment of the present disclosure.

FIG. 17 is a view showing an operating state in which the piston moves backward in the cylinder in the brake apparatus for vehicles according to another embodiment of the present disclosure.

### DETAILED DESCRIPTION

Hereinafter, embodiments of a brake apparatus for vehicles according to the present disclosure will be described with reference to the accompanying drawings. It should be noted that the drawings are not to precise scale and may be exaggerated in thickness of lines or sizes of components for descriptive convenience and clarity only. Furthermore, the terms as used herein are defined by taking functions in the present disclosure into account and can be changed according to the custom or intention of users or operators. Therefore, definition of the terms should be made according to the overall disclosures set forth herein.

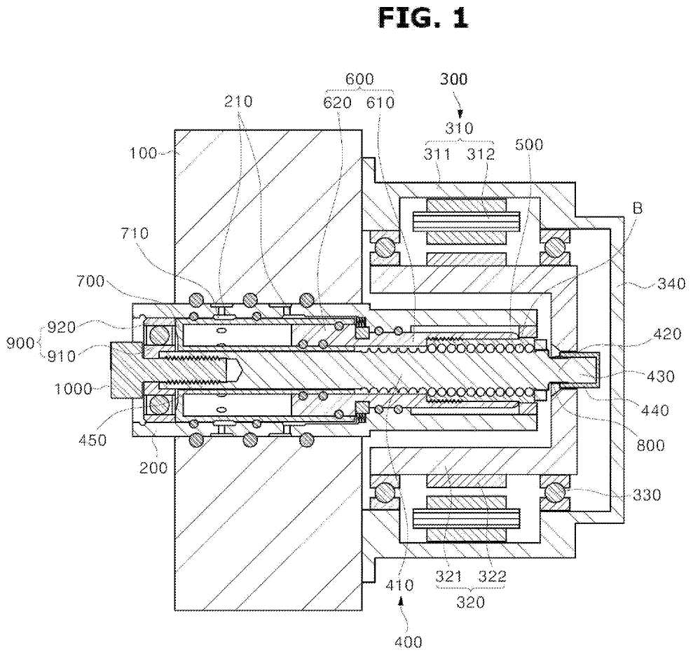

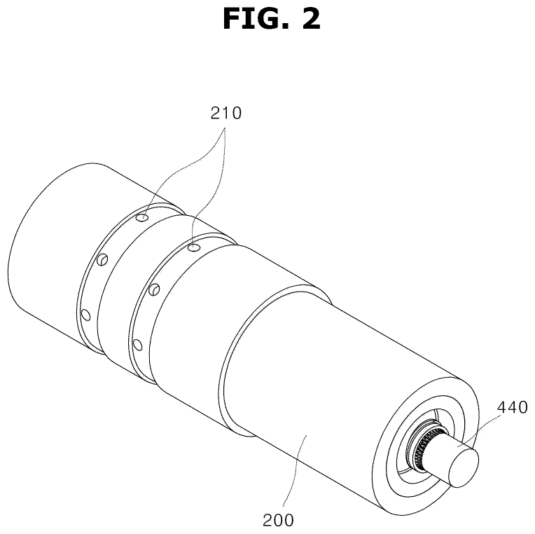

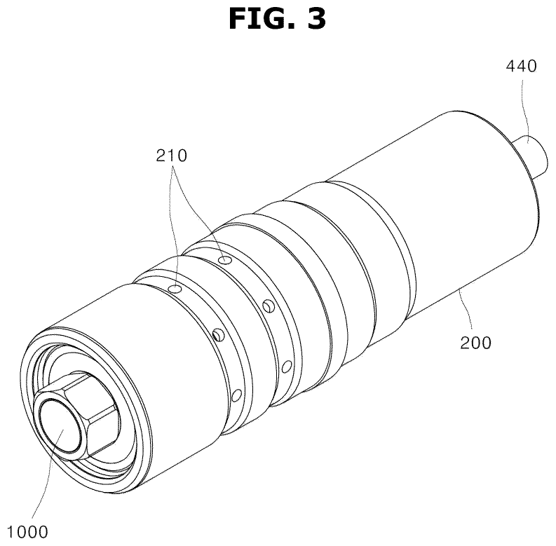

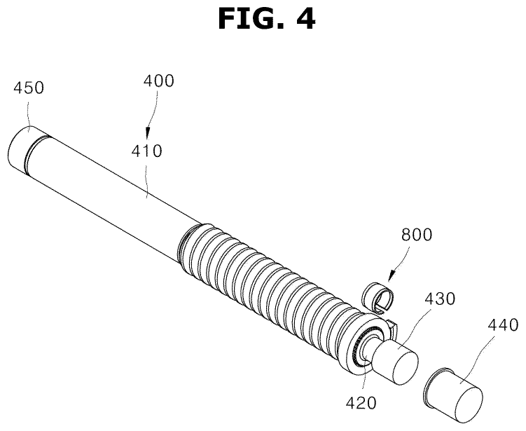

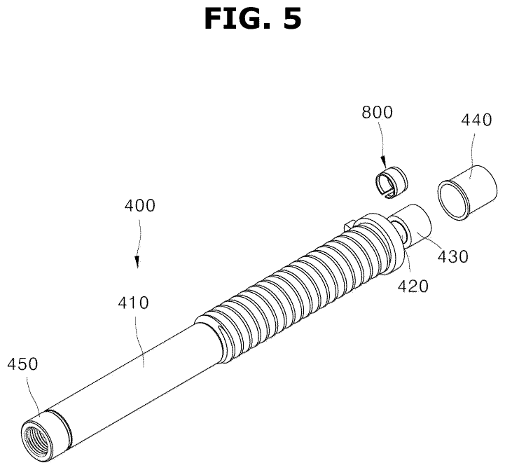

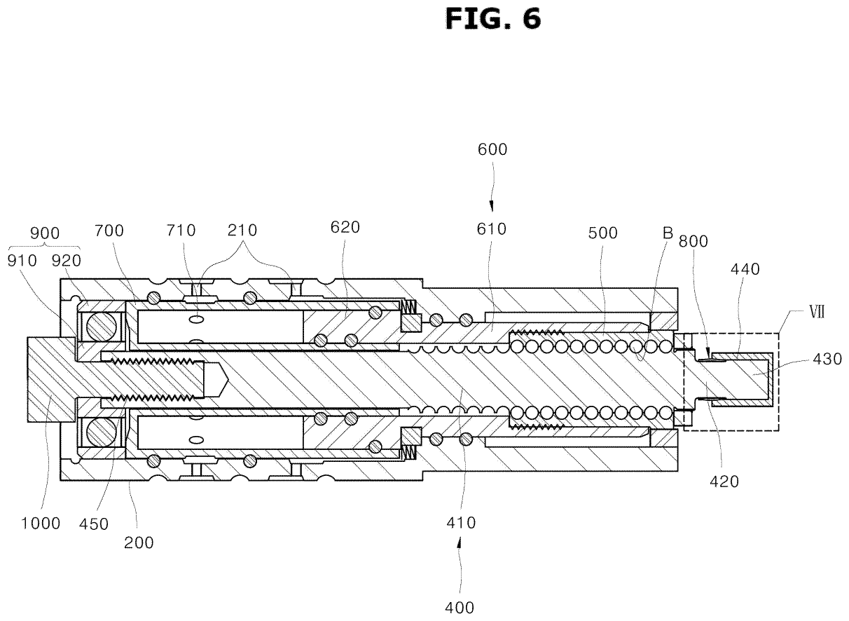

FIG. 1 is a sectional view illustrating a brake apparatus for vehicles according to an embodiment of the present disclosure. FIG. 2 is a perspective view illustrating a cylinder viewed from one direction according to an embodiment of the present disclosure. FIG. 3 is a perspective view illustrating the cylinder of FIG. 2 viewed from another direction. FIG. 4 is an exploded perspective view illustrating the cylinder of FIG. 2. FIG. 5 is an exploded perspective view illustrating the cylinder of FIG. 3. FIG. 6 is a sectional view illustrating the cylinder according to an embodiment of the present disclosure.

Referring to FIGS. 1 to 6, a brake apparatus for vehicles according to an embodiment of the present disclosure may include a cylinder 200, a motor 300, a screw shaft 400, a nut 500, a piston 600, a sleeve 700, and a damper 800, which are described in detail below.

The cylinder 200 may be disposed inside a housing 100 by press-fitting and may withstand torque generated by formation of hydraulic pressure according to reciprocating movement of the piston 600. The housing 100 according to an embodiment of the present disclosure may have a hollow shape in which an internal space is provided.

The housing 100 may be provided on an outer side of the cylinder 200 (at a left side based on FIG. 1). The cylinder 200 may be assembled to the housing 100 under controlled concentricity.

The cylinder 200 may have a hollow shape. The sleeve 700, in which an operation section is provided to allow hydraulic pressure to be formed by pressing of the piston 600, may be provided in one side space (at the left side based on FIG. 1) inside the cylinder 200.

The motor 300 may be connected to the cylinder 200, and various types of drive devices may be used within a technical idea in which rotational power can be generated. The motor 300 may transmit rotational power (torque) to the screw shaft 400.

The motor 300 may include a stationary component 310, a rotational component 320, and a motor bearing 330.

The stationary component 310 may be fixed to the housing 100, and may be formed in various shapes within a technical idea in which magnetic force is changed by supply of power. The stationary component 310 may include a fixing frame 311 fixed to one side of the housing 100 (at a right side based on FIG. 1), and a stator 312 that is disposed on an inner surface of the fixing frame 311 facing the rotational component 320 and is configured to generate magnetic force.

The fixing frame 311 may be connected to one side of the housing 100. The rotational component 320 may be rotatably disposed inside the fixing frame 311.

The stator 312, which is an electromagnet, may be disposed in a circumferential direction on an inner surface of the fixing frame 311, and may rotate the rotational component 320 by changing magnetic flux in response to a control signal from a controller (not shown).

The rotational component 320 may be connected to the screw shaft 400, and may rotate together with the screw shaft 400. The rotational component 320 may be modified into various shapes within a technical idea in which the rotational component 320 can rotate according to a change in magnetic force of the stationary component 310.

The rotational component 320 may be rotatably disposed inside the fixing frame 311. The rotational component 320 may have an approximately “C”-shaped cross-section, and may be formed in a hollow shape.

The rotational component 320 may include a rotational frame 321 disposed in a shape enclosing one side (the right side based on FIG. 1) of the cylinder 200, and a rotor 322 that is disposed on an outer surface of the rotational frame 321 facing the stationary component 310 and has magnetic force.

A spline that engages with the screw shaft 400, which will be described below, may be formed in the rotational frame 321.

The motor bearing 330 may be disposed between the stationary component 310 and the rotational component 320 to reduce friction generated during rotation of the rotational component 320. The rotor 322, which is formed of a plurality of magnets disposed in a circumferential direction of the rotational frame 321, may rotate along with the rotational frame 321 by a change in magnetic force of the stator 312.

A frame cover 340 secured to the fixing frame 311 may be disposed in a shape enclosing an outer surface of an end of the rotational frame 321 to block the entry of foreign substances.

The screw shaft 400 may be provided inside the cylinder 200. The screw shaft 400 may be inserted in a longitudinal direction of the cylinder 200, and may be axially coupled to the cylinder 200.

A central axis of the cylinder 200 and a central axis of the screw shaft 400 may coincide with each other. The screw shaft 400 may be secured to a shaft bearing 900, which will be described below, by a support component 1000.

The screw shaft 400 may include a screw body 410, a neck portion 420, a power transmission portion 430, a shaft cover 440, and a coupling portion 450.

The screw body 410 may be rotatably disposed inside the cylinder 200, and may include a helical thread formed along a longitudinal direction of the screw shaft 400. The screw body 410 may be located inside the rotational frame 321 provided in the motor 300.

The neck portion 420 may protrude from an outer surface around a rotating center of the screw body 410 toward a first side (a right side based on FIG. 1), and may be formed to have a diameter smaller than that of the screw body 410.

The power transmission portion 430 may extend from a free end of the neck portion 420 toward the first side (the right side based on FIG. 1), and may be formed to have a diameter larger than that of the neck portion 420.

A spline may be formed along a circumferential direction on an outer surface of the power transmission portion 430 that faces the rotational frame 321. Accordingly, the rotational frame 321 and the power transmission portion 430 may engage with each other so that power transmission is achieved.

The shaft cover 440 may be provided to enclose the neck portion 420 and the power transmission portion 430. A gap G may be formed between the neck portion 420 and the shaft cover 440. The damper 800, which will be described below, may be disposed in the gap G.

The shaft cover 440 may be interposed between the power transmission portion 430 and the rotational frame 321 to prevent metallic rattle noise from being generated.

A spline may be formed on an outer surface of the shaft cover 440 along a circumferential direction of the shaft cover 440, and may engage with the rotational frame 321. An outer shape of the shaft cover 440 may correspond to an outer shape of the power transmission portion 430.

The coupling portion 450 may extend from the outer surface around the rotating center of the screw body 410 toward a second side (a left side based on FIG. 1), and may be formed to have a diameter smaller than that of the screw body 410.

The coupling portion 450 may be rotatably coupled through the shaft bearing 900, which will be described below.

The nut 500 may be positioned inside the rotational frame 321 provided in the motor 300, and may be provided inside the cylinder 200.

The nut 500 may be coupled to an outer surface of the screw shaft 400 via a ball B.

The screw shaft 400 may be coupled to the nut 500 by penetrating the nut 500. The ball B is provided between a helical thread formed on an inner surface of the nut 500 and the helical thread formed on an outer surface of the screw body 410, so that rotational motion of the screw shaft 400 may be converted into linear motion through the nut 500.

The nut 500 may reciprocate in an axial direction of the screw shaft 400 according to a rotational direction of the screw shaft 400.

The piston 600 may be coupled in a manner of enclosing an outer side of the nut 500. The piston 600 may move in the longitudinal direction of the cylinder 200 in conjunction with the movement of the nut 500.

The piston 600 may include a rod 610 and a head 620.

The rod 610 may be formed in a hollow shape, and may be positioned inside the rotational frame 321 provided in the motor 300. The outer surface of the nut 500 and an inner surface of the rod 610 may be threadedly engaged with each other.

The head 620 may be integrally formed with the rod 610. A diameter of the head 620 may be greater than a diameter of the rod 610.

The head 620 may be formed in a ring shape, may be positioned inside the housing 100, and may reciprocate inside the sleeve 700 to move working fluid inside the sleeve 700 toward ports 210. Accordingly, the cylinder 200 may form a double-acting hydraulic pressure according to reciprocating movement of the piston 600.

The sleeve 700 may be positioned inside the housing 100, and may be provided inside the cylinder 200. The sleeve 700 may guide movement of the piston 600 inserted therein.

The sleeve 700 may be formed to enclose the head 620 of the piston 600.

The ports 210 through which the working fluid flows may be provided on an outer surface of the cylinder 200 that corresponds to the sleeve 700. The ports 210 may be respectively provided on opposite sides of the cylinder 200 in the longitudinal direction. The working fluid that is moved by movement of the piston 600 may be transferred through the ports 210 to implement a required braking pressure.

A cut-off hole 710 in communication with the ports 210 may be formed in the outer surface of the sleeve 700

[symbol]

A plurality of cut-off holes 710 may be arranged to be spaced apart from each other in a circumferential direction of the sleeve 700. Accordingly, the working fluid inside the sleeve 700 may be discharged in a radial direction of the piston 600.

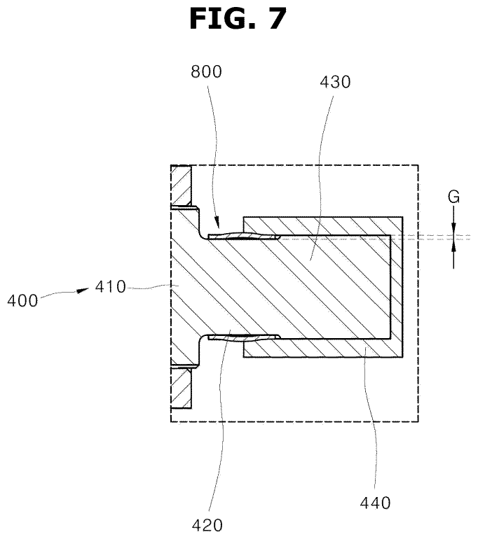

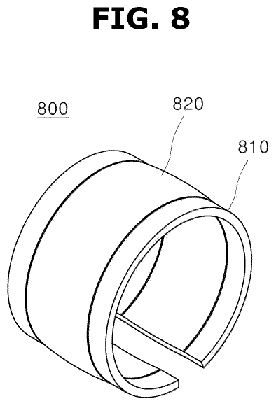

FIG. 7 is an enlarged view showing a portion of FIG. 6. FIG. 8 is a perspective view illustrating a damper according to an embodiment of the present disclosure.

Referring to FIGS. 1 to 8, the damper 800 according to an embodiment of the present disclosure may be coupled to the screw shaft 400. The damper 800 may be disposed to enclose the neck portion 420.

The damper 800 may be disposed in a gap G formed between the neck portion 420 and the shaft cover 440. The damper 800 may be fabricated including a metallic material.

The damper 800 may be elastically deformed to reduce resonance that may occur in the screw shaft 400.

The central axis of the screw shaft 400 may be tilted due to a load generated by hydraulic pressure during forward movement of the piston 600 and due to clearance tolerances. Wobbling of the screw shaft 400 may occur with the coupling portion 450 as a reference point. The degree of the wobbling of the screw shaft 400 may be greatest at the neck portion 420, which is farthest from the coupling portion 450.

In the case where resonance occurs in the screw shaft 400, the greatest wobbling (vibration) may occur at the neck portion 420, which may cause damage to the shaft cover 440, degradation in system performance, and quality issues due to generation of noise and vibration.

When wobbling occurs in the screw shaft 400, the shaft cover 440 may be deformed, and resonance may occur in the gap G. The damper 800 having elasticity may be assembled in a space where resonance may occur, so as to reduce the resonance when it occurs.

The damper 800 may include a damper body 810 and an elastic portion 820.

A central portion of the damper body 810 may be formed to be open in the axial direction of the screw shaft 400, and the damper body 810 may have a ring shape that is circular or elliptical with a set length. The damper body 810 may be formed in an approximately “C” shape with one side of an outer circumferential surface thereof open.

The damper body 810 may be provided to enclose the neck portion 420. The damper body 810 may be interposed between the shaft cover 440 and the neck portion 420.

The elastic portion 820 may protrude convexly from the damper body 810. The elastic portion 820 may protrude in a radial direction of the damper body 810 from the outer circumferential surface of the damper body 810. The elastic portion 820 may be formed along a circumferential direction of the damper body 810.

The elastic portion 820 may elastically support the shaft cover 440. An inner circumferential surface of the elastic portion 820 may not contact an outer circumferential surface of the neck portion 420, and an outer circumferential surface of the elastic portion 820 may be in close contact with an inner circumferential surface of the shaft cover 440 to elastically support the shaft cover 440.

The brake apparatus for vehicles according to an embodiment of the present disclosure may include the shaft bearing 900.

The shaft bearing 900 may be positioned inside the housing 100, and may be provided at an inner end of the cylinder 200.

An outer surface of the shaft bearing 900 and an outer surface of the sleeve 700 may be disposed in contact with each other. The shaft bearing 900 may be coupled to the screw shaft 400 in a shape enclosing the coupling portion 450 of the screw shaft 400.

The shaft bearing 900 may include an inner ring 910 disposed in contact with the coupling portion 450 of the screw shaft 400, and an outer ring 920 disposed in contact with the inner surface of the cylinder 200.

The shaft bearing 900 may support an axial load during formation of hydraulic pressure inside the cylinder 200 by the piston 600 that reciprocates in the axial direction of the screw shaft 400.

The brake apparatus for vehicles according to an embodiment of the present disclosure may include the support component 1000.

The support component 1000 may be provided inside the cylinder 200. An end of the coupling portion 450 may be received inside the support component 1000. The shaft bearing 900 may be secured to an outer circumferential surface of the support component 1000. The support component 1000 may rotatably support the screw shaft 400.

An operation process of the brake apparatus for vehicles according to an embodiment of the present disclosure having the aforementioned configuration will be described below.

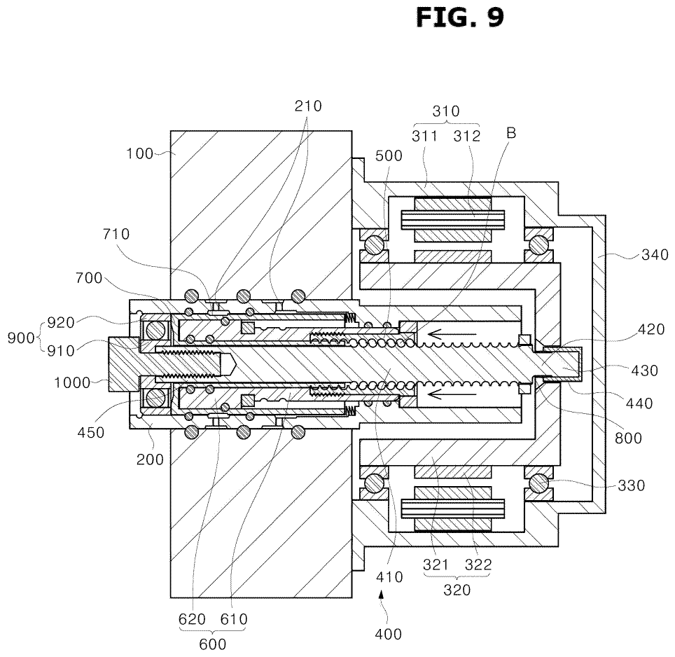

FIG. 9 is a sectional view showing an operating state in which the piston moves forward into the cylinder in the brake apparatus for vehicles according to an embodiment of the present disclosure.

Referring to FIG. 9, when the motor 300 operates to transmit rotational force to the screw shaft 400, the screw shaft 400 may rotate around an axis thereof in a first rotational direction inside the cylinder 200, and the nut 500 may move forward along the screw shaft 400 toward the sleeve 700.

When the nut 500 moves toward the sleeve 700, the piston 600 coupled to the nut 500 moves in conjunction with the nut 500, and moves linearly forward inside the cylinder 200, thus generating hydraulic brake pressure.

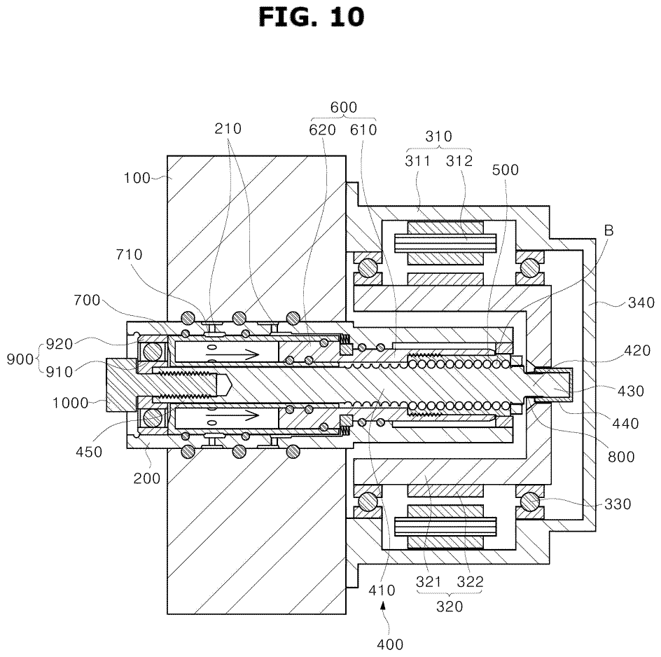

FIG. 10 is a sectional view showing an operating state in which the piston moves backward inside the cylinder in the brake apparatus for vehicles according to an embodiment of the present disclosure.

Referring to FIG. 10, when the motor 300 operates such that the screw shaft 400 rotates around an axis thereof inside the cylinder 200 in a second rotational direction opposite to the first rotational direction, the nut 500 may move backward along the screw shaft 400 in a direction opposite to the sleeve 700.

When the nut 500 moves in the direction opposite to the sleeve 700, the piston 600 coupled to the nut 500 moves in conjunction with the nut 500, and moves linearly backward inside the cylinder 200, thus generating hydraulic brake pressure. Accordingly, as the piston 600 moves linearly forward and backward inside the cylinder 200, a double-acting hydraulic pressure is formed.

In the brake apparatus for vehicles according to an embodiment of the present disclosure, when wobbling of the screw shaft 400 occurs, the damper 800 that is elastically deformable and is disposed in the gap G formed between the neck portion 420 of the screw shaft 400 and the shaft cover 440 may reduce resonance of the screw shaft 400, and may compensate for the wobbling of the screw shaft 400. Therefore, the coupling force between the screw shaft 400 and the motor 300 may be improved.

In the brake apparatus for vehicles according to an embodiment of the present disclosure, an axial load caused by reaction force during formation of hydraulic pressure may be supported in both directions through the shaft bearing 900 coupled to the cylinder 200, so that the axial load due to the hydraulic pressure may be prevented from being transmitted to the motor 300.

In the brake apparatus for vehicles according to an embodiment of the present disclosure, because the motor 300 does not support an axial load, the weights and sizes of the housing 100 and the shaft bearing 900 may be reduced.

In the brake apparatus for vehicles according to an embodiment of the present disclosure, perpendicularity and concentricity may be compensated for by using an inherent clearance of the shaft bearing 900, thereby making it possible to omit existing separate components used for shaft alignment, reducing manufacturing costs, and shortening an overall axial length.

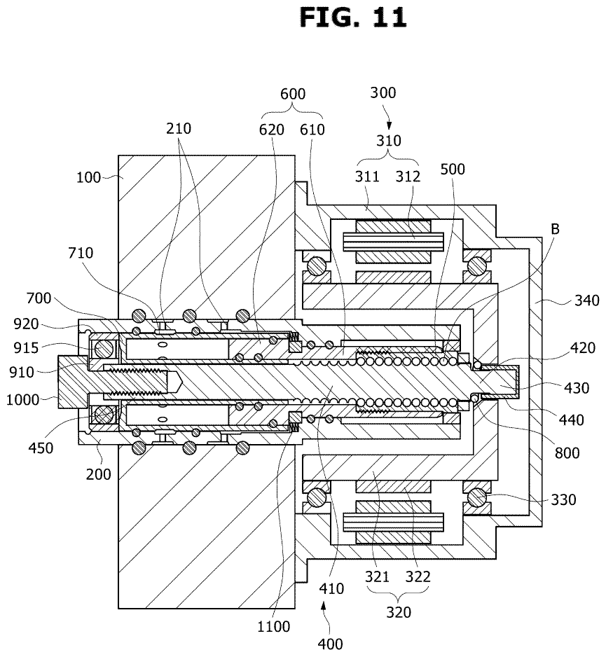

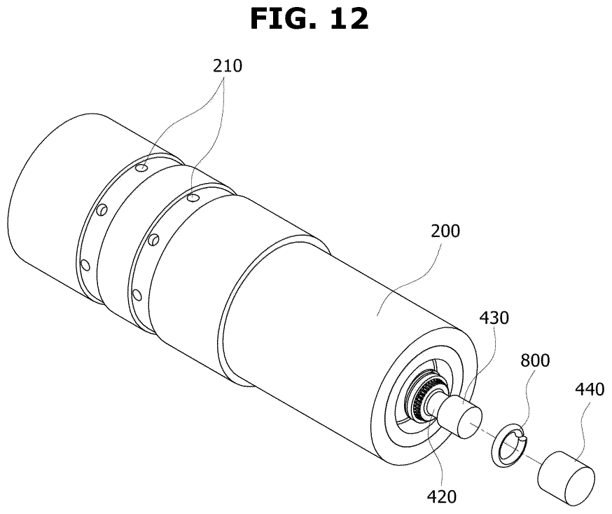

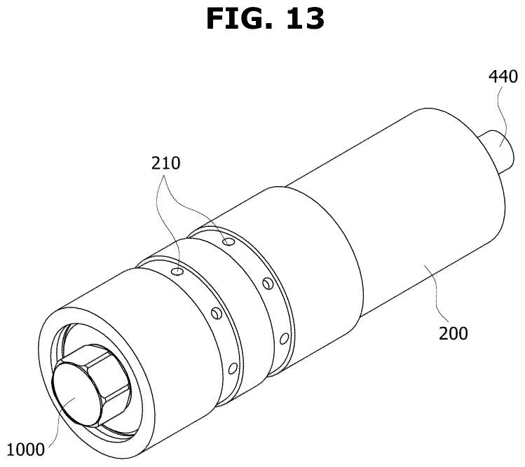

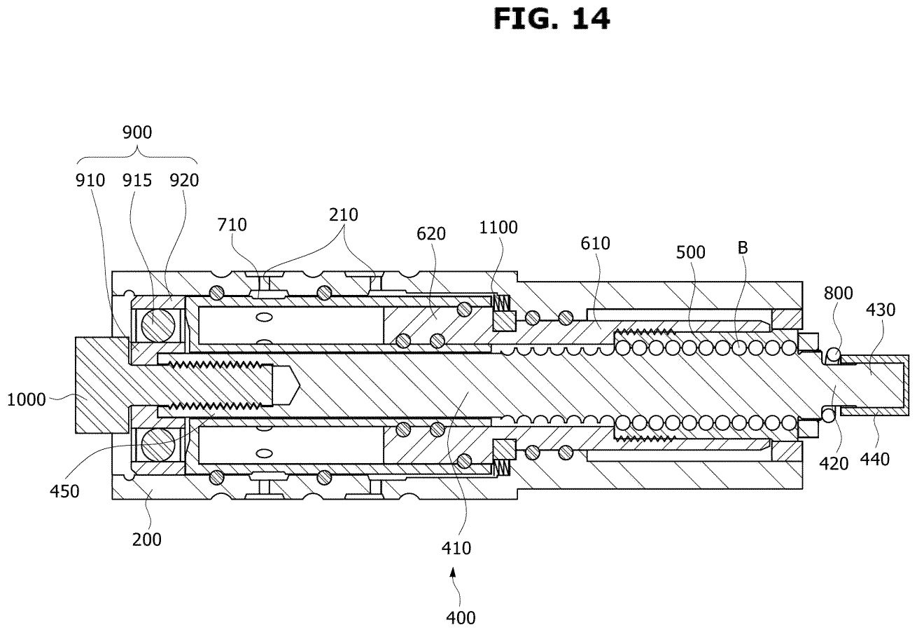

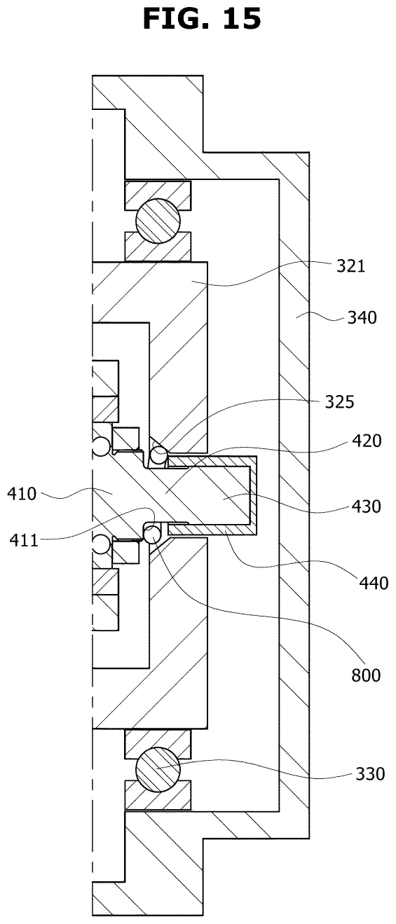

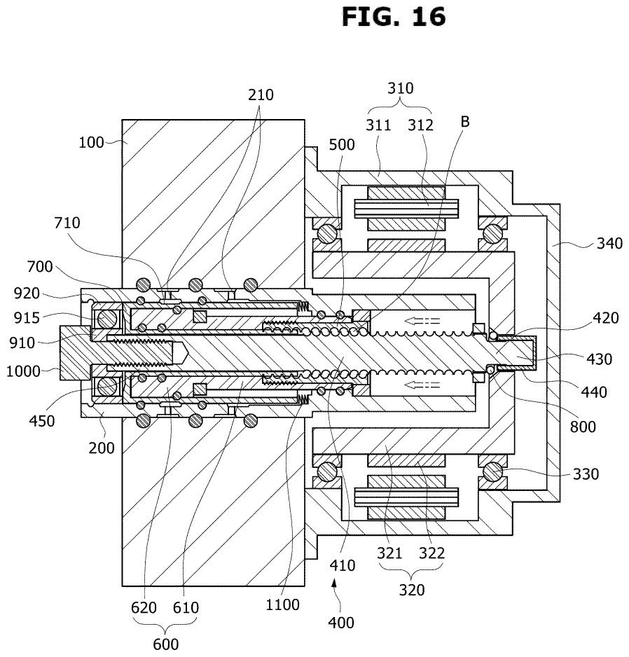

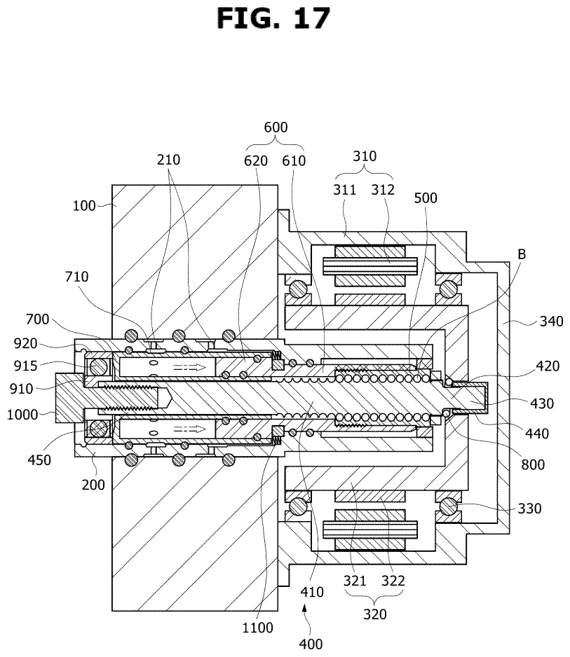

FIG. 11 is a sectional view illustrating a brake apparatus for vehicles according to another embodiment of the present disclosure. FIG. 12 is a perspective view illustrating a cylinder viewed from one direction according to another embodiment of the present disclosure. FIG. 13 is a perspective view illustrating the cylinder of FIG. 12 viewed from another direction. FIG. 14 is a sectional view schematically illustrating the brake apparatus for vehicles according to another embodiment of the present disclosure. FIG. 15 is an enlarged sectional view of a region around a vibration reducer according to another embodiment of the present disclosure. FIG. 16 is a view showing an operating state in which a piston moves forward inside the cylinder in the brake apparatus for vehicles according to another embodiment of the present disclosure. FIG. 17 is a view showing an operating state in which the piston moves backward in the cylinder in the brake apparatus for vehicles according to another embodiment of the present disclosure.

Referring to FIGS. 11 to 17, the brake apparatus for vehicles according to another embodiment of the present disclosure may include a cylinder 200, a motor 300, a screw shaft 400, a nut 500, a piston 600, a sleeve 700, and a vibration reducer 800, which are described in detail below.

The cylinder 200 may be located inside a housing 100 and may withstand torque generated by formation of hydraulic pressure according to reciprocating movement of the piston 600. The housing 100 according to the present embodiment may have a hollow shape in which an internal space is provided, and the cylinder 200 may be press-fitted into the housing 100.

The housing 100 may be provided on an outer side of the cylinder 200 (at a left side based on FIG. 11). The cylinder 200 may be assembled to the housing 100 under controlled concentricity.

The cylinder 200 may have a hollow shape. The sleeve 700, in which an operation section is provided to allow hydraulic pressure to be formed by pressing of the piston 600, may be provided in one side space (at the left side based on FIG. 11) inside the cylinder 200.

The motor 300 may be connected to the cylinder 200, and various types of drive devices may be used within a technical idea in which rotational power can be generated. The motor 300 may transmit rotational power (torque) to the screw shaft 400.

The motor 300 may include a stationary component 310, a rotational component 320, and a motor bearing 330.

The stationary component 310 may be fixed to the housing 100, and may be formed in various shapes within a technical idea in which magnetic force is changed by supply of power.

The stationary component 310 may include a fixing frame 311 fixed to one side of the housing 100 (at a right side based on FIG. 11), and a stator 312 that is disposed on an inner surface of the fixing frame 311 facing the rotational component 320 and is configured to generate magnetic force.

The fixing frame 311 may be connected to one side of the housing 100. The rotational component 320 may be rotatably disposed inside the fixing frame 311.

The stator 312, which is an electromagnet, may be disposed in a circumferential direction on an inner surface of the fixing frame 311, and may rotate the rotational component 320 by changing magnetic flux in response to a control signal from a controller (not shown).

The rotational component 320 may be connected to the screw shaft 400, and may rotate together with the screw shaft 400. The rotational component 320 may be modified into various shapes within a technical idea in which the rotational component 320 can rotate according to a change in magnetic force of the stationary component 310.

The rotational component 320 may be rotatably disposed inside the fixing frame 311. The rotational component 320 may have an approximately “C”-shaped cross-section, and may be formed in a hollow shape.

The rotational component 320 may include a rotational frame 321 disposed in a shape enclosing one side (the right side based on FIG. 11) of the cylinder 200, and a rotor 322 that is disposed on an outer surface of the rotational frame 321 facing the stationary component 310 and has magnetic force.

A spline that engages with the screw shaft 400 may be formed in the rotational frame 321, specifically on an inner surface of the rotational frame 321.

The motor bearing 330 may be provided between the stationary component 310 and the rotational component 320 to reduce friction generated during rotation of the rotational component 320. The rotor 322, which is formed of a plurality of magnets disposed in a circumferential direction of the rotational frame 321, may rotate along with the rotational frame 321 by a change in magnetic force of the stator 312.

A frame cover 340 secured to the fixing frame 311 may be disposed in a shape enclosing an outer surface of an end of the rotational frame 321 to block the entry of foreign substances.

The screw shaft 400 may be provided inside the cylinder 200. The screw shaft 400 may be inserted in a longitudinal direction of the cylinder 200 (a left-right direction based on FIG. 11), and may be axially coupled to the cylinder 200. A central axis of the cylinder 200 and a central axis of the screw shaft 400 may coincide with each other.

The screw shaft 400 may be secured to a shaft bearing 900 by a support component 1000. The support component 1000 may rotatably support the screw shaft 400.

The screw shaft 400 may include a screw body 410, a neck portion 420, a power transmission portion 430, and a coupling portion 450.

The screw body 410 may be rotatably disposed inside the cylinder 200, and may include a helical thread formed along a longitudinal direction of the screw shaft 400. The screw body 410 may be located inside the rotational frame 321 of the motor 300.

The neck portion 420 may protrude from an outer surface around a rotating center of the screw body 410 toward a first side (a right side based on FIG. 11), and may be formed to have a diameter smaller than that of the screw body 410.

The power transmission portion 430 may extend from a free end of the neck portion 420 toward the first side (the right side based on FIG. 11), and may be formed to have a diameter larger than that of the neck portion 420.

A spline may be formed along a circumferential direction on an outer surface of the power transmission portion 430 facing the rotational frame 321. Accordingly, in the case where a shaft cover 440, which will be described later, is not provided, the rotational frame 321 and the power transmission portion 430 may engage with each other to transmit power.

The screw shaft 400 may further include the shaft cover 440. The shaft cover 440 may be disposed to enclose the neck portion 420 and the power transmission portion 430. The shaft cover 440 may be interposed between the power transmission portion 430 and the rotational frame 321 to prevent metallic rattle noise from being generated.

A spline may be formed on an outer surface of the shaft cover 440 along a circumferential direction of the shaft cover 440, and may engage with the rotational frame 321. An outer shape of the shaft cover 440 may correspond to an outer shape of the power transmission portion 430.

A spline may be formed along the circumferential direction on an outer surface of the power transmission portion 430 facing the shaft cover 440. Accordingly, the shaft cover 440 and the power transmission portion 430 may engage with each other to transmit power.

The coupling portion 450 may extend from the outer surface around the rotating center of the screw body 410 toward a second side (a left side based on FIG. 11), and may be rotatably coupled to the shaft bearing 900. The coupling portion 450 may be coupled to the shaft bearing 900 by press-fitting. The coupling portion 450 may be formed to have a diameter equal to or less than that of the screw body 410.

The nut 500 may be positioned inside the rotational frame 321 of the motor 300, and may be located inside the cylinder 200.

The nut 500 may be coupled to an outer surface of the screw shaft 400 via a ball B.

The screw shaft 400 may be coupled through the nut 500. Because the ball B is located between a helical thread formed on an inner surface of the nut 500 and the helical thread formed on an outer surface of the screw body 410, rotational motion of the screw shaft 400 may be converted into linear motion through the nut 500.

A rotation prevention protrusion (not shown) may be formed on an outer surface of the nut 500, and a movement groove (not shown) may be formed in an inner surface of the cylinder 200.

When the screw shaft 400 rotates, the nut 500 does not rotate because rotation of the rotation prevention protrusion of the nut 500 is blocked by the movement groove. Accordingly, the rotational motion of the screw shaft 400 may be converted into the linear motion of the nut 500 by the rotation prevention protrusion and the movement groove.

The nut 500 may reciprocate in an axial direction of the screw shaft 400 according to a rotational direction of the screw shaft 400. For example, if the nut 500 moves forward when the screw shaft 400 rotates in a first direction, the nut 500 may move backward when the screw shaft 400 rotates in a second direction opposite to the first direction.

The piston 600 may be coupled in a manner of enclosing an outer side of the nut 500. The piston 600 may move in the longitudinal direction of the cylinder 200 in conjunction with the reciprocating movement of the nut 500.

The piston 600 may include a rod 610 and a head 620.

The rod 610 may be formed in a hollow shape, and may be positioned inside the rotational frame 321 of the motor 300. The outer surface of the nut 500 and an inner surface of the rod 610 may be threadedly engaged with each other.

The head 620 may be integrally formed with the rod 610. An outer diameter of the head 620 may be greater than an outer diameter of the rod 610.

The head 620 may be formed in a ring shape, may be positioned inside the housing 100, and may reciprocate inside the sleeve 700 to move working fluid inside the sleeve 700 toward ports 210. Accordingly, the cylinder 200 may form a double-acting hydraulic pressure according to reciprocating movement of the piston 600.

The sleeve 700 may be positioned inside the housing 100, and may be disposed inside the cylinder 200. The sleeve 700 may guide movement of the piston 600 inserted therein.

The sleeve 700 may be formed to enclose the head 620 of the piston 600.

The ports 210 through which the working fluid flows may be provided on an outer surface of a region of the cylinder 200 where the sleeve 700 is located. The ports 210 may be respectively provided at a plurality of points along the longitudinal direction of the cylinder 200. Working fluid that moves according to movement of the piston 600 may be transferred through the ports 210 to implement a required braking pressure.

A cut-off hole 710 in communication with the ports 210 may be formed in the outer surface of the sleeve 700.

A plurality of cut-off holes 710 may be arranged to be spaced apart from each other in a circumferential direction of the sleeve 700. Accordingly, the working fluid inside the sleeve 700 may be discharged in a radial direction of the piston 600.

The screw shaft 400 may be tilted on a central axis thereof or wobble due to a load generated by hydraulic pressure during forward movement of the piston 600 or due to clearance tolerances. Tilting or wobbling of the screw shaft 400 may occur with a coupling region between the coupling portion 450 and the support component 1000 as a reference point (a central point).

While the screw shaft 400 wobbles, an amplitude of the screw shaft 400 may gradually increase as a distance from the reference point of the wobbling increases, and may be greatest at the neck portion 420, which is farthest from the reference point of the wobbling.

In the present embodiment, the vibration reducer 800 may prevent the amplitude of the screw shaft 400 from significantly increasing or resonance from occurring in advance. Accordingly, it is possible to prevent the power transmission portion 430 or the shaft cover 440 from being damaged, thereby preventing a failure in normal power transmission from the motor 300 to the screw shaft 400 or the occurrence of quality issues caused by generation of noise and vibration.

In the present embodiment, the vibration reducer 800 may have a first side (a left side in FIG. 15) supported by the screw shaft 400 and a second side (a right side in FIG. 15) supported by the motor 300. Accordingly, the vibration reducer 800 may suppress the neck portion 420 of the screw shaft 400 from vibrating excessively off the central axis of the screw shaft 400 inside the rotational frame 321 of the motor 300.

The neck portion 420 of the screw shaft 400 comes into indirect contact with the rotational frame 321 via the vibration reducer 800. Accordingly, during operation of the brake apparatus for vehicles, the relative displacement between the neck portion 420 of the screw shaft 400 and the rotational frame 321 may be reduced, thereby reducing the amplitude of the screw shaft 400.

The vibration reducer 800 is elastically deformable while being supported by both the screw shaft 400 and the motor 300. Thus, when the screw shaft 400 shakes, the vibration reducer 800 undergoes elastic deformation, thus absorbing the vibration of the screw shaft 400 or the impact caused by the vibration.

The vibration reducer 800 may be a helical coil.

The vibration reducer 800 may be formed in a discontinuous ring shape. That is, as shown in FIG. 12, the vibration reducer 800 may be formed in a ring shape with one side of an outer circumferential surface thereof open.

Because the vibration reducer 800 has two ends, the vibration of the screw shaft 400 can be transmitted to the vibration reducer 800 and then dispersed to the outside through each end of the vibration reducer 800.

The second side of the vibration reducer 800 may be disposed to be spaced farther apart from the sleeve 700 than the first side of the vibration reducer 800.

Based on FIG. 15, the point where the vibration reducer 800 comes into contact with the screw shaft 400 and the point where the vibration reducer 800 comes into contact with the rotational frame 321 of the motor 300 are arranged diagonally. Accordingly, the vibration reducer 800 can absorb vibrations in all directions (360 degrees) around the central axis of the screw shaft 400.

The vibration reducer 800 may include a steel material. More specifically, the vibration reducer 800 may be made of a stainless steel material.

The vibration reducer 800 may be a torsion spring or a torsional coil.

The first side of the vibration reducer 800 may be supported in contact with a stepped portion 411 in a connection region between the screw body 410 and the neck portion 420. Because the stepped portion 411 is formed in a flat surface shape, the first side of the vibration reducer 800 can be elastically supported stably on the stepped portion 411.

The second side of the vibration reducer 800 may be supported in contact with the rotational frame 321 of the motor 300. The second side of the vibration reducer 800 may be supported in contact with a tapered surface 325 of the rotational frame 321. Because the tapered surface 325 is formed in a flat surface shape, the second side of the vibration reducer 800 can be elastically supported stably on the tapered surface 325.

Because the screw shaft 400 is coupled to the nut 500 via the ball B, a certain amount of vibration needs to occur in order to prevent performance degradation or jamming during operational movement. In the present embodiment, the vibration reducer 800 is disposed in a space in which vibration of the screw shaft 400 occurs. Accordingly, when vibration occurs, it is possible to effectively reduce the vibration without restricting degrees of freedom of the vibration of the screw shaft 400.

The vibration reducer 800 may be disposed to enclose the neck portion 420 of the screw shaft 400 without interfering with the shaft cover 440. The vibration reducer 800 may also be disposed so as not to be in contact with an inner circumferential surface of the neck portion 420.

The brake apparatus for vehicles according to another embodiment of the present disclosure may further include the shaft bearing 900.

The shaft bearing 900 may be positioned inside the housing 100, and may be provided at an inner end of the cylinder 200.

An outer surface of the shaft bearing 900 and an outer surface of the sleeve 700 may be disposed in contact with each other. The shaft bearing 900 may be coupled to the screw shaft 400 in a shape enclosing the coupling portion 450 of the screw shaft 400.

The shaft bearing 900 may include an inner ring 910, a bearing ball 915, and an outer ring 920. The inner ring 910 may be disposed in contact with the coupling portion 450 of the screw shaft 400, and the outer ring 920 may be disposed in contact with the inner surface of the cylinder 200.

The shaft bearing 900 may support an axial load during formation of hydraulic pressure inside the cylinder 200 by the piston 600 that reciprocates in the axial direction of the screw shaft 400.

The brake apparatus for vehicles according to another embodiment of the present disclosure may include the support component 1000.

The support component 1000 may be provided inside the cylinder 200. The support component 1000 may be inserted into the coupling portion 450, and may be coupled to the screw shaft 400. The support component 1000 may be threadedly engaged with the screw shaft 400. The shaft bearing 900 may be fixed to the support component 1000. The support component 1000 may rotatably support the screw shaft 400. The support component 1000 may be a bolt.

The brake apparatus for vehicles according to another embodiment of the present disclosure may include a reaction force component 1100.

A first side of the reaction force component 1100 may be supported by the cylinder 200, and a second side of the reaction force component 1100 may be brought into contact with the sleeve 700 to press the sleeve 700 toward the shaft bearing 900. The reaction force component 1100 may be a wave spring.

An operation process of the brake apparatus for vehicles according to another embodiment of the present disclosure having the aforementioned configuration will be described below.

Referring to FIG. 16, when the motor 300 operates to transmit rotational force to the screw shaft 400, the screw shaft 400 may rotate around an axis thereof in a first rotational direction inside the cylinder 200, and the nut 500 may move forward along the screw shaft 400 toward the sleeve 700.

In response to the movement of the nut 500 toward the sleeve 700, the piston 600 coupled to the nut 500 may linearly move forward inside the cylinder 200 in the same direction as the movement direction of the nut 500, thus forming hydraulic brake pressure.

Referring to FIG. 17, when the motor 300 operates such that the screw shaft 400 rotates around an axis thereof inside the cylinder 200 in a second rotational direction opposite to the first rotational direction, the nut 500 may move backward along the screw shaft 400 in a direction opposite to the sleeve 700.

In response to the movement of the nut 500 in the direction opposite to the sleeve 700, the piston 600 coupled to the nut 500 may linearly move backward inside the cylinder 200 in the same direction as the movement direction of the nut 500, thus forming hydraulic brake pressure. Accordingly, as the piston 600 linearly moves forward and backward inside the cylinder 200, a double-acting hydraulic pressure may be formed.

In the brake apparatus for vehicles according to another embodiment of the present disclosure, when wobbling of the screw shaft 400 occurs, an amplitude of the screw shaft 400 may be reduced by the vibration reducer 800 that is elastically deformable and is disposed between the screw shaft 400 and the motor 300, and a coupling force between the screw shaft 400 and the motor 300 may be improved.

The present disclosure provides an effect in which, when wobbling of a screw shaft occurs, a damper that is elastically deformable and is disposed in a gap formed between a neck portion of the screw shaft and a shaft cover may compensate for the wobbling and reduce resonance of the screw shaft, thereby improving a coupling force between the screw shaft and a motor.

The present disclosure provides an effect in which an axial load caused by a reaction force during formation of hydraulic pressure may be supported in both directions through a shaft bearing coupled to a cylinder, thereby preventing the axial load due to the hydraulic pressure from being transmitted to the motor.

In the present disclosure, because the motor does not support an axial load, the weights and sizes of a housing and the shaft bearing may be reduced.

In the present disclosure, perpendicularity and concentricity may be compensated for by using an inherent clearance of the shaft bearing, thereby making it possible to omit existing separate components used for shaft alignment, reducing manufacturing costs, and shortening an overall axial length.

In the present disclosure, a vibration reducer may suppress the screw shaft from vibrating off a central axis.

In the present disclosure, because the vibration reducer is elastically deformable, the vibration reducer may absorb vibration of the screw shaft or impact caused by the vibration.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake apparatus for vehicles, the brake apparatus comprising:
a cylinder;
a motor coupled to the cylinder, and configured to generate rotational power;
a screw shaft disposed inside the cylinder, receiving the rotational power from the motor and rotating around an axis thereof;
a nut coupled to the screw shaft via a ball, and reciprocating in an axial direction of the screw shaft according to a rotational direction of the screw shaft;
a piston coupled to the nut, and moving in conjunction with the nut;
a sleeve disposed inside the cylinder, and guiding a movement of the piston inserted in the sleeve; and
a damper coupled to the screw shaft and being elastically deformable.

2. The brake apparatus of claim 1, wherein the piston comprises:
a rod threadedly engaged with an outer surface of the nut; and
a head integrally formed with the rod, and reciprocating inside the sleeve in a longitudinal direction of the sleeve.

3. The brake apparatus of claim 1, further comprising
a shaft bearing disposed inside the cylinder, and coupled to the screw shaft, the shaft bearing supporting an axial load during formation of hydraulic pressure in the cylinder.

4. The brake apparatus of claim 1, wherein the screw shaft comprises:
a screw body rotatably disposed around an axis thereof in the cylinder;
a neck portion protruding from the screw body;
a power transmission portion extending from the neck portion, and receiving the rotational power from the motor; and
a shaft cover enclosing the neck portion and the power transmission portion.

5. The brake apparatus of claim 4,
wherein the damper includes a metallic material, and
wherein the shaft cover includes a plastic material.

6. The brake apparatus of claim 4, wherein a diameter of the power transmission portion is greater than a diameter of the neck portion.

7. The brake apparatus of claim 6, wherein a gap is disposed between the neck portion and the shaft cover.

8. The brake apparatus of claim 7, wherein the damper comprises:
a damper body interposed between the shaft cover and the neck portion, and enclosing the neck portion; and
an elastic portion protruding convexly from the damper body, and elastically supporting the shaft cover.

9. The brake apparatus of claim 8, wherein the elastic portion protrudes from an outer circumferential surface of the damper body in a radial direction of the damper body, and is formed in a circumferential direction of the damper body.

10. The brake apparatus of claim 8, wherein the damper body is formed in a ring shape with one side of an outer circumferential surface thereof open.

11. A brake apparatus for vehicles, the brake apparatus comprising:
a cylinder;
a motor configured to generate rotational power;
a screw shaft disposed inside the cylinder, receiving the rotational power from the motor and rotating around an axis thereof;
a nut coupled to the screw shaft, and reciprocating in an axial direction of the screw shaft according to rotation of the screw shaft;
a sleeve disposed between the cylinder and the screw shaft;
a piston coupled to the nut, and including a head reciprocating in the sleeve according to the reciprocation of the nut; and
a vibration reducer including a first side supported on the screw shaft, and a second side supported on the motor, the vibration reducer being elastically deformable.

12. The brake apparatus of claim 11, wherein the vibration reducer comprises a helical coil.

13. The brake apparatus of claim 12, wherein the helical coil has a discontinuous ring shape.

14. The brake apparatus of claim 13, wherein the helical coil includes a metallic material.

15. The brake apparatus of claim 11, wherein the vibration reducer comprises a torsion spring.

16. The brake apparatus of claim 11, wherein the screw shaft comprises:
a screw body rotatably disposed around an axis thereof in the cylinder;
a neck portion protruding from the screw body; and
a power transmission portion extending from the neck portion, and receiving the rotational power from the motor,
wherein the first side of the vibration reducer is supported in contact with a stepped portion in a connection region between the screw body and the neck portion.

17. The brake apparatus of claim 11, wherein the second side of the vibration reducer is supported in contact with a tapered surface of the motor.

18. The brake apparatus of claim 11, wherein the second side of the vibration reducer is disposed to be spaced farther apart from the sleeve than the first side of the vibration reducer.

19. The brake apparatus of claim 11, wherein the piston comprises:
a rod coupled to an outer surface of the nut; and
the head integrally formed with the rod, and reciprocating in the sleeve in a longitudinal direction of the sleeve.

20. The brake apparatus of claim 11, further comprising a shaft bearing disposed inside the cylinder, and coupled to the screw shaft, the shaft bearing supporting an axial load during formation of hydraulic pressure in the cylinder.
